(19) United States
(12) Patent Application Publication
(10) Pub. No.: US 2007/0269602 A1
(43) Pub. Date: Nov. 22, 2007

(54) Coating system for metal strips and method for producing metal strips partially coated on one side

(76) Inventors: Leszek Poletek, Ulm (DE); Hermann Sturm, Bellenberg (DE)

Correspondence Address: FLYNN THIEL BOUTELL & TANIS, P.C., 2026 RAMBLING ROAD, KALAMAZOO, MI, 49008-1631, US

(21) Appl. No.: 11/796,197

(22) Filed: Apr. 27, 2007

(30) Foreign Application Priority Data
May 18, 2006 (DE) 102006023282.8

(51) Int. Cl. B05C 1/06; B05D 3/00

(52) U.S. Cl. 427/300; 118/258

(57) ABSTRACT

The invention relates to a coating system for metal strips, consisting of:
a coating roll,
an application device for the coating material,
a mask strip guided over the coating roll by means of deflection rolls, the mask strip being configured endlessly,
a strip guide for the metal strip running over the coating roll.

Another aspect of the invention relates to a method for producing metal strips partially coated on one side by means of the coating system according to the invention.

The present invention relates to a coating system for metal strips and to a method for producing metal strips partially coated on one side by means of the coating system.

It is known to produce metal strips tin-plated on one side by hot tin plating or by electrolytic tin plating.

To this end, document JP 09165661 A discloses a coating method for strips coated on two sides. The surface of the strip to be coated is respectively covered on the front and rear sides by a masking strip and subsequently fed through a solder bath. The masking strip is removed again after the coating and wound up on a drum. A similar method for strip coating is furthermore known from document JP 57047857 A.

U.S. Pat. No. 4,529,628 discloses a coating method for strips tin-plated on one or two sides. In this method, liquid metal from a melt container is applied through a nozzle onto a strip guided vertically past the nozzle. The thickness of the coating is controlled via the strip speed and nozzle output. The coating is continuous over the strip length.

Patent EP 0 735 156 B1 furthermore discloses partially hot tin-plated metal strips, in which a metallic coating extending in the longitudinal direction is applied onto one or both sides of the surface. The coating may consist of a plurality of bands, which are interrupted at certain intervals in the longitudinal direction. To this end, the strip is pretreated with flux and heated before the coating is applied. The metal melt from a storage chamber is applied through an opening of a dosing unit onto the strip moving past, and excess metal melt is scraped off. For partial coating of the surface in the longitudinal direction of the strip, the feed of the metal melt is deliberately regulated via the dosing unit. Such coated strips may be employed in the electronics industry. Coatings of different thickness consist of pure tin or tin alloys, for example, which are applied onto strips of copper or copper alloys.

Patent DE 27 12 003 C2 discloses a method for producing steel strips coated on one side. The steel strips are provided with a coat of zinc, zinc alloy, aluminum or aluminum alloy from a melt container in order to produce corrosion-resistant surfaces. For coating, the metal strip is not immersed in the melt bath but guided along directly over the melt surface. The strip is brought over the melt surface into a position where the surface tension and the wetting properties of the molten coating metal make it possible to form a meniscus on the surface of the melt bath. Owing to the meniscus which is formed, the strip is in direct contact with the melt bath and is thus continuously provided with a coat on the strip side. Partial, i.e. incomplete, coating of the strip surface is not provided.

It is an object of the invention to refine a coating system for metal strips partially coated on one side.

The invention is provided in respect of a coating system by the features of claim 1, and with respect to a production method by the features of claim 10. The further dependent claims relate to advantageous developments and refinements of the invention.

The invention relates to a coating system for metal strips, consisting of:

a coating roll,

an application device for the coating material,

a mask strip guided over the coating roll by means of deflection rolls, the mask strip being configured endlessly,

a strip guide for the metal strip running over the coating roll.

The invention is based on the idea that the metal strip to be partially coated is guided together with the mask strip over the coating roll. In particular, for example, liquid tin or a tin alloy is applied as a metal layer onto a metal strip of copper or a copper alloy. The mask strip has openings at the positions where the coating is intended to be applied onto the metal strip. Excess tin is scraped off over a plurality of stages before separating the metal strip and the mask strip.

The mask strip is configured endlessly. Such strips running over different tension and guide rolls are particularly expedient in terms of manufacturing technology. Depending on the material of the mask strip, a cleaning instrument may also be provided with which the residues of the coating material can be removed. In the case of non-wetting materials, however, additional cleaning may be obviated.

The metal strip to be coated is deflected over the coating roll and clamped with the required strip tension, so as to ensure that no liquid coating material reaches the rear side of the metal strip.

The mask strip is likewise prestressed with the required tension, so that no coating material enters the gap between the metal strip and the mask strip. The forward feed rates of the metal strip and the mask strip are correspondingly adapted to one another so that no relative movement takes place between the metal strip and the mask strip.

The particular advantage is that one-sided coating on metal strips can be produced reliably and with little outlay. In the regions where the coating is applied, the metal strip comes in contact on its rear side with the coating roll, so that further precautions to protect the rear side of the strip are no longer necessary. Depending on the process management, the excess coating material is deliberately removed in order to adjust the desired layer thickness. In particular, the coating system according to the invention is also suitable for producing tin-containing surface layers on strip material of copper or copper alloys.

In the simplest form, the coating roll has a uniform cylindrical shape over the entire length. In the case of a cylindrical shape, the strip material bears surface-wide on the roll surface.

In an advantageous configuration of the invention, the surface of the coating roll may be shaped concavely or conically toward the roll middle. In the case of concave curvatures, the edge regions of the metal strip are pressed more strongly onto the roll surface, so that additional sealing is achieved at the strip edges. A conical shape, in which the radius of the coating roll continuously decreases toward the roll middle as seen from both ends, has a similar effect. In a particular form of the concave coating roll, essentially only those regions where the coating roll comes in contact with the strip edges have a curvature of the roll surface. In other words, the surface of the coating roll is slightly curved convexly only in the region of the resting strip edges, and has a cylindrical shape thereafter in the direction of the roll middle. The coating roll thus has a slightly smaller radius toward the roll middle than the roll outer edge. This particular configuration of the roll surface leads to slight bulging at the respective edges of the metal strip relative to an otherwise flatly resting strip surface, which, under tensioning, seals the peripheral regions particularly well against the melt. Ingress of liquid coating material into a gap formed between the coating roll on the strip material can thus be reliably prevented.

Further advantages are obtained if at least the surface of the coating roll consists of a material which is not wettable by the coating material. In the case of tin plating on one side with a coating roll immersed in a melt bath, it is particularly important for no coating material to adhere on the surface of the roll. To this end, either surfaces or solid material repelling the metal melt are suitable. Particularly in connection with tin-containing coating materials, iron or ceramic material, for example aluminum oxide, silicon nitride or graphite may be envisaged.

Advantageously, at least the surface of the mask strip may consist of a material which is not wettable by the coating material. The mask strip itself may thus be made from a solid material, or superficially coated with a material, which is not wetted by the coating material.

In a preferred configuration of the invention, the application device may comprise a slotted coating nozzle extending in the direction toward the coating roll. In this case, for example, liquid tin as a coating material is applied above the coating roll, i.e. immediately after the mask strip and the metal strip come together. Excess tin may also be scraped or blown off over a plurality of stages, in order to adjust the desired layer thickness.

As an alternative, it is furthermore preferred that the application device may comprise a melt bath, into which the coating roll is partly immersed. In this case, the metal strip to be coated on one side is guided through the melt bath while bearing tightly on the coating roll. Undesired ingress of the metal melt on the rear side of the metal strip is thus avoided.

In a preferred configuration, the axis of the coating roll immersed into the melt bath may be arranged over the melt bath surface. In this way, the coating roll is brought only partially in contact with the melt, and the metal strip to be coated and the mask strip only have to bear on one another in this contact region. It would also be conceivable for the coating roll to be arranged only close to the melt surface, albeit so close that a coating is applied by means of the surface tension of the melt bath and the strip surface to be coated. Then, however, it is necessary to ensure that the melt contact is not interrupted. In this case, besides the metal strip to be coated, the mask strip may also need to be partially or fully wetted by the melt of the coating material.

The application device may advantageously have a scraper instrument. The scraper instrument may in this case be a scraper element and/or a blower nozzle. By means of the coating process, the coating material is usually applied in excess onto the metal strip to be coated. In particular, in the case of metal layers containing tin, the desired final thicknesses of the coating are often much less than the thickness of the material originally applied. Excess tin is thus scraped off over a plurality of stages before separating the metal strip and the mask strip, in order to deliberately adjust the layer thickness.

Advantageously, at least the application device may be arranged in a closed housing with protective gas in order to avoid oxide formation, in particular on the uncoated strip side.

Another aspect of the invention, in respect of a method for producing metal strips partially coated on one side by means of the coating system according to the invention, comprises the following steps:

a metal strip is guided over a coating roll,

the strip surface lying opposite the coating roll is covered with an endlessly configured mask strip,

a coating is applied on the metal strip in the covered region, and

the excess coating material is removed down to a desired layer thickness, before the mask strip is removed from the surface of the metal strip.

Other advantages and configurations of the invention will be explained in more detail with the aid of the schematic drawings, in which:

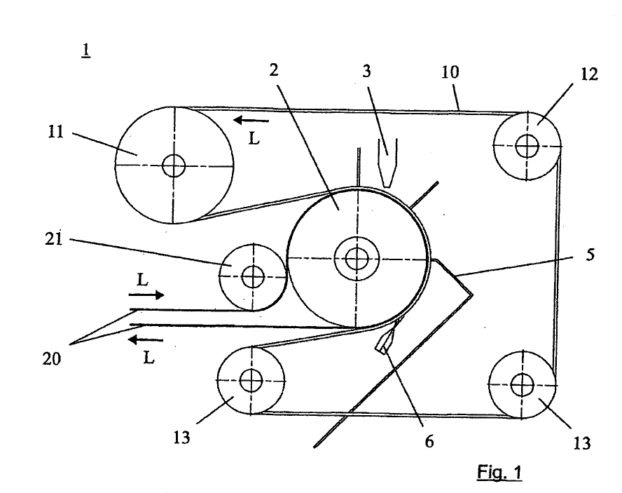

FIG. 1 shows a coating system with a coating nozzle and

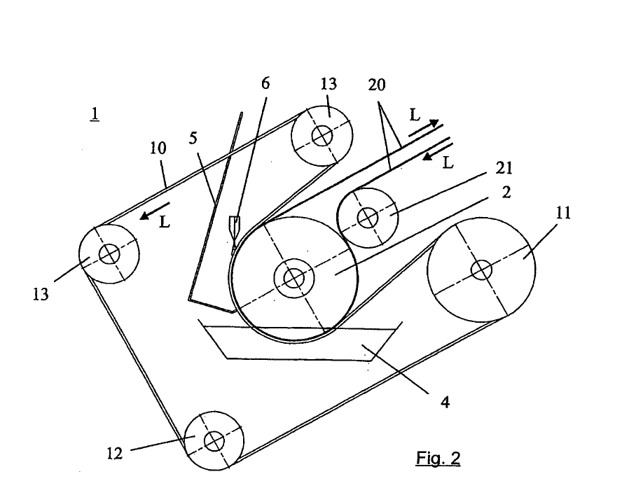

FIG. 2 shows a coating system with a melt bath.

Parts corresponding to one another are provided with the same reference numerals in all the figures.

FIG. 1 shows a coating system 1, in which the metal strip 20 to be partially coated is guided together with the mask strip 10 over the coating roll 2. The application device contains a coating nozzle 3 extending in the axial direction with respect to the coating roll 2. As can be seen from FIG. 1, for example, liquid tin as coating material is applied above the coating roll 2, i.e. immediately after the mask strip 10 comes together with the metal strip 20. The mask strip 10 has openings at the positions where the coating is intended to be applied onto the metal strip 20. The mask strip 20 is made from a flexible material, which is not wetted by the coating material.

The metal strip 10 to be coated is guided over the coating roll 2 and clamped with the required strip tension by a deflection roll as a strip guide 21, so as to ensure that no liquid coating material reaches the rear side of the metal strip 20. The running direction L of the metal strip 20 and of the mask strip 10 is respectively denoted by an arrow.

The mask strip 10 is likewise prestressed with the required tension by a deflection-tension roll 12, so that no coating material can enter the gap between the metal strip 20 and the mask strip 10. The forward feed rates of the metal strip 20 and of the mask strip 10 are correspondingly adapted to one another by means of the driving mask strip roll 11, so that no relative movement takes place between the metal strip 20 and the mask strip 10.

The mask strip 10 is guided endlessly over the driving mask strip roll 11, the deflection-tension roll 12 and two further mask strip deflection rolls 13. In the case of a material not wettable by the melt for the mask strip 10, an additional cleaning device is superfluous.

Since in the case of metal layers containing tin, the desired end thickness of the coating is much less than the thickness of the material originally applied, excess tin is removed over two stages in order to adjust the desired layer thickness. The scraper instrument provided for this consists of a scraper element 5 and a blower nozzle 6.

FIG. 2 represents another example of a coating system 1 with a melt bath 4. Instead of with a coating nozzle 3, the one-sided tin plating is now carried out with a coating roll 2 immersed in a melt bath 4. This consists of ceramic solid material, so that no coating material adheres on the surface of the coating roll 2.

The coating roll 2 is only partly immersed in the melt bath 4. The metal strip 20 to be coated on one side is guided through the melt bath 4 while bearing tightly on the coating roll 2, in order to avoid undesired ingress of the metal melt on the rear side of the metal strip 20.

In the coating system 1 represented in FIG. 2, the axis of the coating roll 2 is not immersed into the melt bath 4. In this way, the coating roll 2 is brought only partially in contact with the melt, and the metal strip 20 to be coated and the mask strip 10 bear on one another only in this contact region, in the region of the scraper element 5 and the blower nozzle 6.

Further process units may be connected upstream, for example a chemical or mechanical instrument for cleaning the strip surface before coating. There may likewise be further process units downstream, for example an oven for heat-treating the applied metal layer.

### LIST OF REFERENCES

1 coating system
2 coating roll
3 coating nozzle
4 melt bath
5 scraper element
6 blower nozzle
10 mask strip
11 driving mask strip roll
12 deflection-tension roll
13 mask strip deflection roll
20 metal strip
21 strip guide for metal strip
L running direction

1. Coating system (1) for metal strips, consisting of:
a coating roll (2),
an application device (3, 4, 5, 6) for the coating material,
a mask strip (10) guided over the coating roll (2) by means of deflection rolls (11, 12, 13), the mask strip (10) being configured endlessly,
a strip guide (21) for the metal strip (20) running over the coating roll (2).

2. Coating system according to claim 1, characterized in that the surface of the coating roll (2) is shaped concavely or conically toward the roll middle.

3. Coating system according to claim 1, characterized in that at least the surface of the coating roll (2) consists of a material which is not wettable by the coating material.

4. Coating system according to claim 1, characterized in that at least the surface of the mask strip (10) consists of a material which is not wettable by the coating material.

5. Coating system according to claim 1, characterized in that the application device (3, 5, 6) comprises a slotted coating nozzle (3) extending in the direction toward the coating roll (2).

6. Coating system according to claim 1, characterized in that the application device (4, 5, 6) comprises a melt bath (4), in which the coating roll (2) is partly immersed.

7. Coating system according to claim 6, characterized in that the axis of the coating roll (2) immersed into the melt bath (4) is arranged over the melt bath surface.

8. Coating system according to claim 1, characterized in that the application device (3, 4, 5, 6) has a scraper element (5) and/or a blower nozzle (6).

9. Coating system according to claim 1, characterized in that at least the application device (3, 4, 5, 6) is arranged in a closed housing with protective gas.

10. Method for producing metal strips (20) partially coated on one side by means of a coating system (1) according to claim 1, characterized in that
a metal strip (20) is guided over a coating roll (2),
the strip surface lying opposite the coating roll (2) is covered with an endlessly configured mask strip (10),
a coating is applied on the metal strip (20) in the covered region, and
the excess coating material is removed down to a desired layer thickness, before the mask strip (10) is removed from the surface of the metal strip (20).
